(19) United States
(12) Patent Application Publication
(10) Pub. No.: US 2023/0128380 A1
(43) Pub. Date: Apr. 27, 2023

(54) PERFLUOROPHENYL AZIDE-CONTAINING SILOXANE OLIGOMER MIXTURES

(71) Applicant: WACKER CHEMIE AG, Munich (DE)

(72) Inventors: Maximilian MOXTER, Munich (DE); Thomas RENNER, Munich (DE); Richard WEIDNER, Burghausen (DE)

(73) Assignee: Wacker Chemie AG, Munich (DE)

(21) Appl. No.: 17/914,888

(22) PCT Filed: Mar. 27, 2020
(86) PCT No.: PCT/EP2020/058787

§ 371 Date: Sep. 27, 2022

(51) Int. Cl. C08G 77/24; C08G 77/26; C09D 183/08

(52) U.S. Cl. CPC C08G 77/24; C08G 77/26; C09D 183/08; C08G 2150/00; C08G 2170/00

(57) ABSTRACT

A perfluorophenyl azide containing siloxane oligomer mixture along with products made therefrom, uses for the same, methods for preparing and methods for curing the same.

The present invention relates to PFPA-containing siloxane oligomer mixtures selected from compounds of average formula (I). The invention also relates to mixtures comprising at least one PFPA-containing siloxane oligomer mixture according to the invention and at least one natural or synthetic polymer, and to moldings comprising at least one mixture according to the invention and a weakly polar to non-polar substrate, and also to a method for curing the mixtures and to the use of these mixtures and to the use of the PFPA-containing siloxane oligomer mixtures.

The invention relates to mixtures for coating surfaces in order to render these water-repellent or to impart to them other desired properties typical of silicones, and also to the products resulting therefrom.

It is known that organopolysiloxanes may be applied to surfaces, for example textiles, paper and plastics, in order to render the surfaces water-repellent or non-adhesive or to impart lubricity to them. The organopolysiloxanes most frequently used for this purpose are polymethylsiloxanes or mixtures with methylhydrogenpolysiloxanes. Although the organopolysiloxanes produce the desired surface properties, they often lack sufficient durability. They can be removed, by example, by washing or on contact with organic solvents.

Organopolysiloxanes exhibit only limited adhesion to substrates such as, for example, polyolefins, polyethylene terephthalate, polyvinylidene difluoride or polycarbonate, which is due to the weakly polar to non-polar nature of the substrates. Consequently, no mechanically stable bonding to the various materials by covalent binding can be achieved. Currently, adhesion to such materials can only be achieved by oxygen plasma treatment in a complex and multi-stage process. After the surface of a plastic part has been activated in this way, there are three possibilities to achieve adhesion: 1) an adhesion promoter is applied directly in the plasma and the polymer is then sprayed, 2) an adhesion promoter is applied outside of the plasma and the polymer is then sprayed, 3) the polymer is sprayed directly; however, this presupposes that the injection-molding material has already been mixed with an adhesion promoter, which reacts during the polymerization (U. Stöhr, Vakuum in Forschung and Praxis 2015, 27, 16-21).

EP2151467 already discloses an azido-functional polyorganosiloxane crosslinker of the formula Me₃Si—O-(Me₂SiO)₈₀-(Me(3-azidopropyl)SiO)₁₀—SiMe₃ and α,ω-(3-azidopropyl)-terminated polydimethylsiloxane of a viscosity of 1000 mPas for crosslinking siloxanes by means of a “click reaction” on Cu catalysts. The “click reaction” refers to the specific reaction mechanism of a 1,3-dipolar [2+3]-cycloaddition between terminal alkynes and azides, which inevitably forms triazoles. However, this mixture cannot promote adhesion to non-polar substrates.

Furthermore, silanes having functional azido groups, which are bonded via a link with a carbon chain to the silicon atom, are already known. For example, the group of the silylazidoformates N₃—(C═O)—O—R—SiR¹ₙ(OR²)₃₋ₙ, the silylsulfonic acid azides N₃—SO₂—R—SiR¹n(OR²)₃₋ₙ and the silylcarbamic acid azides N₃—(C═O)—NH—R—SiR¹ₙ(OR²)₃₋ₙ (cf. EP0050768). These azidosilanes are suitable, due to their bifunctional character—they have alkoxy groups on the silicon atom and an azide group on a link—as so-called adhesion promoters between organic polymers and inorganic substrates. Applications of azidosilanes and azidosiloxanes for adhesion promotion are known from the literature; to date, however, they are in most cases azide-functionalized monosil(ox)anes as reactive primer.

EP0050768 discloses indirectly azide-containing monosil(ox)anes of the formula N₃—R—SiR¹ₙ(OR²)₃₋ₙ where R=a divalent hydrocarbon radical having 1-8 carbon atoms, which is free from ethylenically unsaturated bonds and of which the hydrocarbon chain optionally present is optionally interrupted once by —O—, —S— or —NR³— (R³=H, Me, Et, Ph), R¹=a monovalent alkyl radical having up to three carbon atoms, phenyl, benzyl or toluyl, R²=an alkyl radical having up to four carbon atoms, phenyl, benzyl or an alkoxyalkyl radical having up to a total of four carbon atoms, n=0, 1 or 2. These azidosilanes serve as intermediates since they react by hydrolysis or partial hydrolysis to give the siloxanes according to the invention, which have an azido group at both ends of the molecule. Specifically disclosed as hydrolysis product is the dimer of N₃-propyltriethoxysilane (N₃—PTES) (example 12). The siloxanes according to the invention are relatively stable to heat and can form covalent bonds via the nitrene intermediate, to give organic polymers for example.

EP0018503 discloses azide-containing mono- and oligosil(ox)anes of the formula Y—(CH₂)ₓ—SiR′ₙ(OR)₃₋ₙ where Y=an azide, x=an integer between 1 and 20, R and R′=linear or branched alkyl or cycloalkyl group having 1-10 carbon atoms or substituted or unsubstituted aromatic group having 6-10 carbon atoms, for improving the crosslinking of elastomers or rubber. Specifically disclosed are trimethoxysilylmethyl azide, 2-(trimethoxysilyl)ethyl azide, 3-(trimethoxysilyl)propyl azide, 4-(trimethoxysilyl)butyl azide, 3-(triethoxysilyl)propyl azide and 4-(triethoxysilyl)butyl azide.

WO9205207 discloses azidosilanes of the formula N₃—(X)ₘSi(OR)₃) where X=a divalent hydrocarbon group having 1-6 carbon atoms, R=an alkyl group having 1-20 carbon atoms and m=0 or 1, azidopropyltriethoxysilane and azidopropyltrimethoxysilane being specifically disclosed. The azidosilanes are suitable for producing crosslinkable organic polymers. Here, the azide group binds to the polymer, the polymer being crosslinkable via the hydrolyzable alkoxy groups.

The use of azide-functionalized oligomeric or polymeric silicones for adhesion promotion is currently known in the literature only with azidoformate substituents. For instance, DE2308162 discloses the coating of a solid organic polymer with an organosiloxane having azidoformate substituents of low thermal stability (decomposition from 80° C.), molecules of which have at least one unit of the general formula (A) N₃—OCOR′-RₐSiO_{(3-a)/2} and at least one unit of the general formula (B) R″_{b}SiO_{(4-b)/2}, in which R and R″ are in each case hydrogen atoms or monovalent hydrocarbon or halogenated hydrocarbon radicals having less than 19 carbon atoms, R′ is a divalent aliphatic radical having 1-12 hydrocarbon atoms consisting of carbon, hydrogen and optionally oxygen or sulfur, wherein any oxygen is in the form of ether bonds, —OC(═O)— groups or —OC(═O)O— groups and any sulfur is in the form of sulfide groups —CSC—, a=0, 1 or 2 and b=1, 2 or 3, and is present in the at least one mole percent units (A). Thus, a coating of an organosiloxane having azidoformate substituents is applied to the surface of a solid organic polymer and cured.

Mingdi Yan et al. disclose, in diverse publications, perfluorinated phenyl azides (PFPA), particularly N-hydroxysuccinimide-functionalized PFPAs (PFPA-NHS), and use thereof as agents for surface modification. In particular, the immobilization of polymers on various substrates is investigated using N-(3-trimethoxysilylpropyl)-4-azido-2,3,5,6-tetrafluorobenzamide (“PFPA-silane”), e.g. in J. Am. Chem. Soc. 2006, 128(43), 14067-14072 or Chem. Eur. J. 2007, 13, 4138-4144.

US2008/0214410 discloses PFPA-containing monosil(ox)anes as primers, specifically disclosed being the so-called “PFPA-silane” (FIG. 1, Examples 1+3). Also disclosed is the immobilization of polystyrene (Example 2), poly(2-ethyloxazoline) (Example 4) and poly(4-vinylpyridine) (Example 5) on Si wafers by the “PFPA-silane”.

WO03087206 discloses “PFPA-silane” as primer for multi-stage polymer coating. Also disclosed as substrates are silicon-containing substrates such as silicon, silica, glass, mica or quartz. The preparation of “PFPA-silane” was first disclosed by Bartlett et al. (Adv. Mater. 2001, 13, 1449-1451), a further method for the preparation being disclosed in WO03/087206.

US2010/028559 discloses, inter alia, the coating of contact lens surfaces with carbohydrate-containing polymers by means of priming the surface with “PFPA-silane” (FIG. 1). In addition, the “PFPA-silane” is bonded to silicon substrates such as SiO₂ nanoparticles and coated with polymers (Example 1, FIG. 2).

WO98/22542 discloses the chemical functionalization of surfaces with perhalogenated phenyl azides, particularly N-hydroxysuccinimide-functionalized PFPAs. Reference is also made by Keana et al. to a method for preparing PFPA-NHS (PFPA 1a) in J. Org. Chem. 1990, 55, 3640-3647.

EP2236524 discloses macromolecules based on PFPA, in which PFPA-NHS is bonded to polyallylamine (PAAm-g-PFPA) or bovine serum albumin (BSA-g-PFPA). These macromolecules are used for coating various substrates. The vinyl-terminated polydimethylsiloxane SYLGARD 184 is bonded covalently to Teflon® (Tetex from Franz Eckart GmbH) with PAAm-g-PFPA (Example 20). In this case, the PAAm-g-PFPA in the polydimethylsiloxane is crosslinked under UV irradiation. Good adhesion of the PDMS to Teflon® is achieved.

The prior art essentially discloses azide-containing monosiloxanes as adhesion promoters between organic and inorganic materials. In essence, the technologies applied here for coating hydrocarbon-based substrates use a reactive primer with azide-containing monosiloxanes and occasionally oligosiloxanes. The known systems of azide-containing polysiloxanes are accessible either by cohydrolysis (of monomers, EP0050768) or by crosslinking (EP2236524) of azide-containing alkoxymonosiloxanes. The azide-containing polymers known to date (alkyl azides, azidoformates, etc.), due to their non-stabilizing hydrocarbon skeleton, are thermally labile even from 80° C. and can thus only be handled safely to a limited extent. The azidosiloxanes described mostly serve as primers for the later coating; self-adhesive crosslinkable silicone compositions for weakly polar to non-polar plastics are neither described nor known with this technology.

Therefore, the object further consists of enabling adhesion of natural or synthetic polymers to weakly polar to non-polar substrates, ideally by means of a self-adhering, mechanically stable surface coating. Therefore, moldings consisting of substrate and polymer surface coating, and also laminated or multi-component moldings, would also be accessible.

This object is achieved by the PFPA-containing siloxane oligomer mixtures of claims 1-4, the mixtures of claim 5, the moldings of claims 6-7, and also the method of curing the mixtures according to the invention of claims 8-12 and the use as claimed in claims 13 and 14.

The invention relates to PFPA-containing siloxane oligomer mixtures selected from compounds of average formula (I)

[SiO_{4/2}]ₐ[RSiO_{3/2}]_{b}[R¹SiO_{3/2}]_{b′}[R²SiO_{2/2}]_{c}[R¹₂SiO_{2/2}]_{c′}[RR¹SiO_{2/2}]_{c″}[R₃SiO_{1/2}]_{d}[R₂R¹SiO_{1/2}]_{d′}[RR¹₂SiO_{1/2}]_{d″}[R¹₃SiO_{1/2}]_{d′″} (I),

wherein

the indices a, b, b′, c, c′, c″, d, d′, d″ and d′″ specify the average content of the respective siloxane units in the mixture and are each independently a number in the range of 0 to 300, with the proviso that the sum total of all indices is in a range from 3 to 3500 and on average at least 2 R radicals are present;

and the radicals R¹ are each independently selected from the group consisting of (i) hydrogen, (ii) halogen, (iii) C₁-C₂₀-hydrocarbon radical, (iv) hydroxyl radical and (v) C₁-C₂₀-hydrocarbonoxy radical;

and the radicals R are identical and refer to a radical of the formula

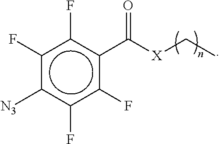

in which the radical X is selected from (i) —O— or (ii) —NH—; and in which the index n (i) is a value in the range from 0 to 10 when X=—O—, and (ii) is a value in the range from 1 to 10 when X=—NH—.

Examples of compounds of the average formula (I) are the following polysiloxanes: RMe₂Si—O—(SiMe₂—O)_{c}(SiRMe-O)_{c″}—SiMe₂R where c=1 to 250 and c″=0 to 250, where the radicals R have the same definition as in formula (I).

The radicals R¹ in formula (I) are preferably each independently selected from the group consisting of (i) hydrogen radical, (ii) methyl radical, (iii) ethyl radical, (iv) phenyl radical, (v) vinyl radical, (vi) hydroxyl radical, and (vii) C₁-C₂₀-alkoxy radical. All R¹ radicals are particularly preferably identical and are a methyl radical.

In the radicals R in formula (I), the radicals X are preferably each independently selected from (i) —O— or (ii) —NH—, in which the index n (i) has a value in the range of 0 to 6 when X=—O—, and (ii) has a value in the range of 1 to 6 when X=—NH—. In the radicals R in formula (I), particularly preferably the radical X=—NH— where n=3.

The indices a, b, b′, c, c′, c″, d, d′, d″ and d′″ in formula (I) each independently have the following definitions:

a=a number in the range from 0 to 250, b=a number in the range from 0 to 50, b′=a number in the range from 1 to 250, c=a number in the range from 1 to 280, c′=a number in the range from 1 to 280, c″=a number in the range from 1 to 280, d=a number in the range from 0 to 250, d′=a number in the range from 0 to 250, d″=a number in the range from 0 to 250 and d′″=a number in the range from 0 to 250, with the proviso that the sum total of all indices is in the range of 3 to 3000 and on average at least 2 and at most 20 R radicals are present.

Particular preference is given to linear PFPA-containing siloxane oligomer mixtures of the average formula (I) for which applies: a=b=b′=d=d′=d′″=0, where the sum of all other indices is in a range from 3 to 2000, and wherein in the radicals R, the radicals X are each independently selected from (i) —O— or (ii) —NH—, where the index n (i) has a value in the range of 0 to 6 when X=—O—, and (ii) has a value in the range of 1 to 6 when X=—NH—, and wherein the radicals R¹ are each independently selected from the group consisting of (i) hydrogen radical, (ii) methyl radical, (iii) phenyl radical, (iv) vinyl radical, (v) hydroxyl radical and (vi) 01-020-alkoxy radical.

The invention further relates to mixtures comprising
a) at least one PFPA-containing siloxane oligomer mixture according to the invention, and
b) at least one natural or synthetic polymer selected from the group consisting of
   b1) addition-crosslinking silicone compositions,
   b2) condensation-crosslinking silicone compositions,
   b3) hybrid materials/STP; and
   b4) inorganic and/or organic polymers.

In the context of the present invention, the term addition-crosslinking silicone compositions refers to hydrolyzable mixtures consisting of hydridopolysiloxanes and alkenyl-containing organopolysiloxanes and fillers (e.g. silicas), which are crosslinked thermally or photochemically in the presence of suitable catalysts (e.g. platinum-based) to give silicone elastomers (examples: DE4336703—Wacker Chemie GmbH; U.S. Pat. No. 5,145,932—Toray Silicon Co., Ltd.; U.S. Pat. No. 4,609,574—Dow Corning Corp.; EP444960A2—Shin Etsu Chemical Co., Ltd.; J. of Appl. Polymer Sci. 47, 2254, 1993).

In the context of the present invention, the term condensation-crosslinking silicone compositions refers to mixtures of hydroxy-terminated organopolysiloxanes and multifunctional polysiloxane crosslinkers (e.g. R—SiX₃ where X=alkoxy, carboxy or amino) which, due to moisture and in the presence of a catalyst (e.g. organotin or organotitanium compound), condense to the three-dimensional networks (with elimination of water, alcohols, acetic acid or amines) (examples: DE11719315—Wacker Chemie GmbH; U.S. Pat. No. 3,696,090—General Electric; U.S. Pat. No. 3,471,434—Stauffer Chemical Co.; FR2511384B1—Rhone-Poulenc; U.S. Pat. No. 5,073,586—Dow Corning).

In the context of the present invention, the term hybrid materials/STP refers to reactive silane-terminated organic polymers, polyethers for example, which are used, for example, as adhesives and sealants or coating materials (e.g. EP3371270B1—Wacker Chemie AG).

In the context of the present invention, the term inorganic and/or organic polymers refers to natural and synthetic inorganic polymers, for example silicas, silicate structures, polysilanes or polysiloxanes, and natural and synthetic organic polymers for producing moldings, coatings or laminates (examples: U.S. Pat. No. 5,792,812—ShinEtsu Chemical Co., Ltd., US2007/0141250—Dow Corning Taiwan Inc. and U.S. Pat. No. 4,686,124—Fuji Systems Corp.).

The invention further relates to moldings comprising at least one mixture according to the invention and a weakly polar to non-polar substrate.

Suitable as weakly polar to non-polar substrate are particularly synthetic hydrocarbon polymers, such as polyolefins of mono- or polyenes, polyhaloolefins, polyethers, polyvinyl chloride, polyvinylidene difluoride, polycarbonates, polyesters, and copolymers of the corresponding monomers (e.g. EPDM or acrylonitrile-butadiene-styrene copolymers (ABS)) and any polymer blends of the polymers and/or copolymers mentioned above. The substrate is preferably selected from the group consisting of polyethylene (PE), polypropylene (PP), polyvinyl chloride (PVC), polyvinylidene difluoride (PVDF), polycarbonate (PC), polystyrene (PS), polytetrafluoroethene (PTFE) and polyethylene terephthalate (PET), and copolymers of the corresponding monomers and polymer blends of the aforementioned polymers and/or copolymers. The substrate is particularly preferably selected from the group consisting of polyethylene (PE), polypropylene (PP), polyvinyl chloride (PVC), polyvinylidene difluoride (PVDF), polycarbonate (PC), polytetrafluoroethene (PTFE) and polyethylene terephthalate (PET).

A molding is preferably a molding selected from the group consisting of extrusion or injection molded moldings, single- or multi-layered laminates (e.g. produced by spin coating, calendaring or dip-coating processes), moldings that can be encapsulated (e.g. in electrocoating by filling, dipping or plasticizing), moldings that may be bonded or sealed or junctions between identical or different moldings of identical or different substrates.

The invention further relates to a method for curing the mixtures according to the invention by thermal and/or photochemical activation.

Preference is given to a method in which the curing takes place by a one-stage or multi-stage thermal activation in the temperature range of 0° C. to 200° C. Thermal activation particularly preferably takes place in a temperature range of 10° C. to 180° C.

One particular embodiment of the invention is a method in which the curing takes place by a two-stage thermal activation comprising the following steps of

a) thermal activation at a temperature T1 in a temperature range of 0° C. to 140° C., and

b) thermal activation at a temperature T2 in a temperature range of 120° C. to 180° C.; wherein it must apply that: T1<T2.

The multi-stage embodiment allows crosslinking and adhesion promotion of the mixtures according to the invention to be induced time-delayed with respect to each other. In the temperature range below 140° C., crosslinking of the polymeric constituents is initially activated, the stable PFPA-containing siloxane oligomer mixture can thus diffuse to the contacting surface and is only definitively activated by a temperature increase to above 120° C.

Preference is also given to a method in which the curing is effected by a one-stage or multi-stage photochemical activation with actinic radiation in the wavelength range of 800 nm to 50 nm. The photochemical activation is particularly preferably activated with actinic radiation in the wavelength range of 500 nm to 100 nm.

The invention further relates to the use of the PFPA-containing siloxane oligomer mixtures according to the invention as adhesion promoters. Preferably as adhesion promoters for addition- and/or condensation-crosslinking silicone compositions.

The invention further relates to the use of the mixtures according to the invention as self-adhesive silicone compositions as coating materials for weakly polar to non-polar substrates, particularly synthetic hydrocarbon polymers such as have been defined above. The substrates are particularly preferably selected from the group consisting of polyethylene (PE), polypropylene (PP), polyvinyl chloride (PVC), polyvinylidene difluoride (PVDF), polycarbonate (PC), polytetrafluoroethene (PTFE) and polyethylene terephthalate (PET).

### EXAMPLES

Instruments:

XPS

XPS analysis was carried out using a PhI5000 VersaProbe spectrometer (ULVAC-PHI INC.) with a 180° spherical capacitor energy analyzer and a multichannel detector (16 channels). The spectra were recorded at a base pressure of 5*10⁻⁸ Pa with focussed scanning using a monochromatic Al-Ka source (1486.6 eV) with a spot size of 200 μm and 47.6 W. The instrument was operated in the FAT analyzer mode, in which the electrons were emitted at an angle of 45° to the sample surface. The pass energy used for the measuring scans was 187.85 eV for overview scans and 46.95 eV for detailed spectra.

Charge neutralization was effected using a cold cathode electron beam source (1.2 eV) and very low energy Ar+ ions (10 eV) during the whole analysis.

The data were analyzed using the CasaXPS [Version 2.3.15, www.casaxps.com] program. The signals were integrated by the Shirley background subtraction method. Sensitivity factors were calculated with the aid of published ionization cross-sections (Scofield, J. H. J. J. Elec. Spec. Rel. Phen. 1976, 8, 129.) and corrected for attenuation, transfer function of the instrument and sample to analyzer angle. Consequently, the amounts measured are stated as apparent normalized atomic concentration, in which the precision under the selected conditions is ca. ±10%.

NMR

Bruker Avance III HD 400 Spectrometer with BBO probe head; 150 mg of methylpolysiloxane mixtures in 500 μl of CDCl₃.

UV Lamp

UV radiometer UVPAD from Opsytec Dr. Gröbel (spectral range: 200-440 nm±5 nm; light intensity:2-5000 mW/cm²)

Chemicals:

WACKER® FLUID NH15D: double (3-aminopropyldimethylsilyloxy)-end-capped PDM-siloxane having an intermediate chain length of average 15, a viscosity between 10 and 20 mm²/s at a mean molar mass of ca. 1100 g/mol. Commercially available from Wacker Chemie AG.

WACKER® FLUID SLM92512: double (3-aminopropyldimethylsilyloxy)-end-capped PDM-siloxane having an intermediate chain length of average 200, a viscosity between 300 mm²/s and 400 mm²/s at a mean molar mass of ca. 15 000 g/mol. Available on request from Wacker Chemie AG.

PFPA-NHS: N-Hydroxysuccinimide-functionalized perfluorophenyl azide, commercially available, for example from abcr GmbH or TCI Chemicals Ltd. (CAS No.

ELASTOSIL® RT604 A/B: Room temperature crosslinking silicone rubber (RTV-2). Commercially available from Wacker Chemie AG.

### 1) Preparation of PFPA-Modified Siloxanes

### Example 1: Synthesis of (PFPA)₂-PDMS₁₅

WACKER® FLUID NH15D (1.54 g, 1.40 mmol) is dissolved in 10 mL of THF at room temperature. PFPA-NHS (0.715 g, 3.08 mmol, 2.2 equivalents based on the amine content of the siloxane) and triethylamine (311 mg, 3.08 mmol) are added to the solution and stirred at room temperature. After 1 hour the formation of a colorless precipitate is observed, the mixture being further stirred overnight. Subsequently, all volatile constituents are removed to dryness under reduced pressure, the residue is taken up in diethyl ether (30 mL) and treated as follows: (i) extraction twice with 2N hydrochloric acid, (ii) single extraction with 1N aqueous sodium hydroxide solution and (iii) washed twice with saturated sodium chloride solution. The organic phase is dried over magnesium sulfate and the solvent is removed under vacuum (10⁻² mbar).

A yellow oil is obtained (yield: 1.882 g, 87%)

1H-NMR (400.1 MHz; CDCl3): δ=0.09 ppm (90H; m, Si—CH3), 0.61 ppm (4H, m, Si-CH2-CH2-CH2—NH-PFPA), 1.67 ppm (4H, m, Si-CH2-CH2-CH2—NH-PFPA), 3.46 ppm (4H, m, Si-CH2-CH2-CH2—NH-PFPA), 6.01 ppm (1H, —NH-PFPA). 19F-NMR (376.5 MHz; CDCl3): δ=141.0, 150.5 ppm.

### Example 2: Synthesis of (PFPA)₂-PDMS₂₀₂

WACKER® FLUID SLM92512 (1.57 g, 0.104 mmol) is dissolved in 10 mL of THF at room temperature. PFPA-NHS (77.5 mg, 0.233 mmol, 2.2 equivalents based on the amine content of the siloxane) and triethylamine (23.2 mg, 0.229 mmol) are added to the solution and stirred at room temperature overnight. Subsequently, all volatile constituents are removed to dryness under reduced pressure, the residue is taken up in diethyl ether (30 mL) and treated as follows: (i) extraction twice with 2N hydrochloric acid, (ii) single extraction with 1N aqueous sodium hydroxide solution and (iii) washed twice with saturated sodium chloride solution. The organic phase is dried over magnesium sulfate and the solvent is removed under vacuum (2-10 mbar). A yellow oil is obtained (yield: 1.6 g, 100%).

1H-NMR (400.1 MHz; CDCl3): δ=0.09 ppm (1750H; m, Si—CH3), 0.61 ppm (4H, m, Si-CH2-CH2-CH2—NH-PFPA), 1.67 ppm (4H, m, Si-CH2-CH2-CH2—NH-PFPA), 3.46 ppm (4H, m, Si-CH2-CH2-CH2—NH-PFPA), 6.01 ppm (1H, —NH-PFPA). 19F-NMR (376.5 MHz; CDCl3): δ=140.9, 150.5 ppm.

### 2) Investigation of the Adhesion Properties on PP, PC, PET, PTFE, PVDF

### Example 3: Coating Process and Surface Analysis

Selected substrate materials—PP, PC, PET, PTFE, and PVDF—are provided as 1×1 cm sized plates and are cleaned three times with isopropanol in an ultrasound bath for 20 minutes. In the case of plasma pre-treatment, the selected material is exposed to oxygen plasma for 5 minutes. The coating is carried out by means of spin coating using n-hexane solutions (concentration 5 mg/mL) of the respective modified silicone (PFPA₂—NH15D) or of the unmodified silicone (WACKER® FLUID NH15D). Layer thicknesses between 40 and 55 nm are produced. The reaction (crosslinking/curing/etc.) is triggered either by UV-C treatment (10 minutes 3.4 mW/cm²) or by heat treatment (2 hours at 140° C.). Each sample is then extracted three times with n-hexane (PC) or ethyl acetate (PP, PET, PTFE, PVDF) and dried in a gas stream. The elemental composition of the surface is investigated by XPS analysis and the theoretical element contents (C, N, O, F, Si) to be expected are compared with the experimental. The results are shown in Tables 1-5.

Table 1: XPS analysis PP, Table 2: XPS analysis PET, Table 3: XPS analysis PC,

Table 4: XPS analysis PTFE, Table 5: XPS analysis PVDF

TABLE 1
XPS Analysis of polypropylene samples.
a) NH15D and PFPA-modified NH15D

| | a) WACKER ® FLUID NH15D | | | | b) PFPA₂-NH15D | | | | | |
|---|---|---|---|---|---|---|---|---|---|---|
| | Composition | | | theoret. | Composition | | | | PP blank | |
| Batch: | 1 | 2 | 3 | proportion | 4 | 5 | 6 | theoret. proportion | | |
| Plasma pre-treatment | x | | | | | | | | | x |
| Temperature activation | | | x | | | x | | | | |
| UV activation | | x | | | | | X | | | |
| C | 75.8 | 99.1 | 99.4 | 48.4 | 99.4 | 66.4 | 56.7 | 52.1 | 99.6 | 83.9 |
| N | 2.2 | 0 | 0 | 3.2 | 0 | 2.5 | 3 | 4.2 | 0 | 1.1 |
| O | 15.8 | 0.6 | 0.6 | 24.2 | 0.5 | 15.2 | 19.3 | 17.7 | 0.4 | 14.8 |
| F | 0 | 0 | 0 | 0 | 0 | 2.7 | 3 | 8.3 | 0 | 0 |
| Si | 6.3 | 0.3 | 0 | 24.2 | 0.1 | 13.2 | 18 | 17.7 | 0 | 0.2 |
| Total | 100.0 | 100.0 | 100.0 | 100.0 | 100.0 | 100.0 | 100.0 | 100.0 | 100.0 | 100.0 |
| Evaluation of the coating | − | − | − | | − | + | + | | | |

b)SLM92512 and PFPA-modified SLM92512

| | a) WACKER ® FLUID SLM92512 | | | | b) PFPA₂-SLM92512 | | | | | |
|---|---|---|---|---|---|---|---|---|---|---|
| | Composition | | | theoret. | Composition | | | | PP blank | |
| Batch: | 7 | 8 | 9 | proportion | 10 | 11 | 12 | theoret. proportion | | |
| Plasma pre-treatment | x | x | x | | x | x | x | | | x |
| Temperature activation | | | x | | | x | | | | |
| UV activation | | x | | | | | X | | | |
| C | 71.4 | 67.8 | 59.5 | 49.9 | 77.1 | 63.4 | 55.6 | 50.2 | 99.6 | 83.9 |
| N | 1.9 | 1.4 | 0.3 | 0.3 | 1.1 | 0.9 | 0.5 | 0.5 | 0 | 1.1 |
| O | 18.4 | 20.1 | 20.8 | 24.9 | 17.8 | 21.3 | 22.3 | 24.2 | 0.4 | 14.8 |
| F | 0 | 0 | 0 | 0.0 | 0 | 0.3 | 0.3 | 0.9 | 0 | 0 |
| Si | 8.3 | 10.7 | 19.4 | 24.9 | 4.0 | 14.1 | 21.3 | 24.2 | 0 | 0.2 |
| Total | 100.0 | 100.0 | 100.0 | 100.0 | 100.0 | 100.0 | 100.0 | 100.0 | 100.0 | 100.0 |
| Evaluation of the coating | − | − | − | | − | − | + | | | |

TABLE 2
XPS Analysis of polyethylene terephthalate samples.
a) NH15D and PFPA-modified NH15D

| | a) WACKER ® FLUID NH15D | | | | b) PFPA₂-NH15D | | | | |
|---|---|---|---|---|---|---|---|---|---|
| | Composition | | | theoret. | Composition | | | | PET blank |
| Batch: | 13 | 14 | 15 | proportion | 16 | 17 | 18 | theoret. proportion | |
| Plasma pre-treatment | x | x | x | | | | | | |
| Temperature activation | | | x | | | x | | | |
| UV activation | | x | | | | | x | | |
| C | 62.7 | 54.9 | 58.3 | 48.4 | 61.8 | 55.4 | 54.6 | 52.1 | 67 |
| N | 2.2 | 1.8 | 2.1 | 3.2 | 2.1 | 3 | 3.6 | 4.2 | 1.2 |
| O | 26.4 | 21.9 | 24.3 | 24.2 | 27.9 | 19.6 | 20.5 | 17.7 | 31.4 |
| F | 0 | 0 | 0 | 0 | 0.4 | 3.6 | 3.1 | 8.3 | 0 |
| Si | 8.7 | 21.4 | 15.3 | 24.2 | 7.8 | 18.4 | 18.2 | 17.7 | 0.4 |
| Total | 100.0 | 100.0 | 100.0 | 100.0 | 100.0 | 100.0 | 100.0 | 100.0 | 100.0 |
| Evaluation of the coating | − | − | − | | − | + | + | | |

b)SLM92512 and PFPA-modified SLM92512

| | a) WACKER ® FLUID SLM92512 | | | | b) PFPA₂-SLM92512 | | | | |
|---|---|---|---|---|---|---|---|---|---|
| | Composition | | | theoret. | Composition | | | | PET blank |
| Batch: | 19 | 20 | 21 | proportion | 22 | 23 | 24 | theoret. proportion | |
| Plasma pre-treatment | x | x | x | | x | x | x | | |
| Temperature activation | | | x | | | x | | | |
| UV activation | | x | | | | | X | | |
| C | 59.2 | 57.1 | 51.1 | 49.9 | 60.2 | 52.9 | 51.3 | 50.2 | 67 |
| N | 1.5 | 1.0 | 0 | 0.3 | 1.1 | 0* | 0* | 0.5 | 1.2 |
| O | 28.5 | 28.4 | 23.7 | 24.9 | 30.9 | 23.8 | 23.3 | 24.2 | 31.4 |
| F | 0 | 0 | 0 | 0.0 | 0 | 0.5 | 0.5 | 0.9 | 0 |
| Si | 10.8 | 13.5 | 25.2 | 24.9 | 7.7 | 22.8 | 24.9 | 24.2 | 0.4 |
| Total | 100.0 | 100.0 | 100.0 | 100.0 | 100.0 | 100.0 | 100.0 | 100.0 | 100.0 |
| Evaluation of the coating | − | − | − | | − | + | + | | |

*nitrogen proportion in higher molecular weight siloxane too low for error-free detection

TABLE 3
XPS analysis of polycarbonate samples (treated according to example 3).
a) NH15D and PFPA-modified NH15D

| | a) WACKER ® FLUID NH15D | | | | b) PFPA₂-NH15D | | | | | |
|---|---|---|---|---|---|---|---|---|---|---|
| | Composition | | | theoret. | Composition | | | | PC blank | |
| Batch: | 25 | 26 | 27 | proportion | 28 | 29 | 30 | theoret. proportion | | |
| Plasma pre-treatment | x | | x | | | | | | | x |
| Temperature activation | | | | | | | | | | |
| UV activation | | x | x | | | | x | | | |
| C | 61.9 | 58.5 | 58.5 | 48.4 | 85.7 | | 58.2 | 52.1 | 90.3 | 73.1 |
| N | 3.1 | 2.5 | 2.5 | 3.2 | 0.3 | | 2.9 | 4.2 | 0.9 | 1.6 |
| O | 21.8 | 21.5 | 21.5 | 24.2 | 13.4 | | 19.3 | 17.7 | 8.8 | 25.3 |
| F | 0 | 0 | 0 | 0 | 0.2 | | 3 | 8.3 | 0 | 0 |
| Si | 13.2 | 17.5 | 17.5 | 24.2 | 0.4 | | 16.6 | 17.7 | 0 | 0 |
| Total | 100.0 | 100.0 | 100.0 | 100.0 | 100.0 | | 100.0 | 100.0 | 100.0 | 100.0 |
| Evaluation of the coating | − | − | − | | − | | + | | | |

b)SLM92512 and PFPA-modified SLM92512

| | a) WACKER ® FLUID SLM92512 | | | b) PFPA₂-SLM92512 | | | | |
|---|---|---|---|---|---|---|---|---|
| | Composition | | theoret. | Composition | | | PC blank | |
| Batch: | 31 | 32 | proportion | 33 | 34 | theoret. proportion | | |
| Plasma pre-treatment | x | x | | x | x | | | x |
| Temperature activation | | | | | | | | |
| UV activation | | x | | | X | | | |
| C | 67.2 | 61.0 | 73.1 | 67.0 | 49.5 | 50.2 | 90.3 | 73.1 |
| N | 1.0 | 1.4 | 1.6 | 1.7 | 0* | 0.5 | 0.9 | 1.6 |
| O | 24.4 | 24.8 | 25.3 | 25.1 | 25.2 | 24.2 | 8.8 | 25.3 |
| F | 0 | 0 | 0 | 0 | 0* | 0.9 | 0 | 0 |
| Si | 10.4 | 12.8 | 0 | 6.5 | 25.3 | 24.2 | 0 | 0 |
| Total | 100.0 | 100.0 | 100.0 | 100.0 | 100.0 | 100.0 | 100.0 | 100.0 |
| Evaluation of the coating | − | − | | − | + | | | |

*proportion in the higher molecular weight siloxane too low for error-free detection; no thermal activation possible since polycarbonate is dimensionally stable only up to 125° C. and also has a glass transition at 150° C.

TABLE 4
XPS Analysis of polytetrafluoroethene samples.

| | a) WACKER ® FLUID NH15D | | | | b) PFPA₂-NH15D | | | | PTFE |
|---|---|---|---|---|---|---|---|---|---|
| | Composition | | | theoret. | Composition | | | | blank |
| Batch: | 35 | 36 | 37 | proportion | 38 | 39 | 40 | theoret. proportion | |
| Plasma pre-treatment | | | x | | | | | | |
| Temperature activation | | | | | | x | | | |
| UV activation | | | x | | | | x | | |
| C | — | — | 37.3 | 48.4 | 38.3 | 38.5 | 38.6 | 52.1 | 39.5 |
| N | — | — | 0 | 3.2 | 0 | 0 | 0 | 4.2 | 0 |
| O | — | — | 0 | 24.2 | 0 | 1.5 | 3.1 | 17.7 | 0 |
| F | — | — | 62.7 | 0 | 61.7 | 60 | 56.1 | 8.3 | 60.5 |
| Si | — | — | 0 | 24.2 | 0 | 0 | 2.2 | 17.7 | 0 |
| Total | — | — | 100.0 | 100.0 | 100.0 | 100.0 | 100.0 | 100.0 | 100.0 |
| Evaluation of the coating | — | — | — | | — | — | — | | |

TABLE 5
XPS Analysis of polyvinylidene difluoride samples.

| | a) WACKER ® FLUID NH15D | | | | b) PFPA₂-NH15D | | | | PVDF |
|---|---|---|---|---|---|---|---|---|---|
| | Composition | | | theoret. | Composition | | | | blank |
| Batch: | 41 | 42 | 43 | proportion | 44 | 45 | 46 | theoret. proportion | |
| Plasma pre-treatment | | | | | | | | | |
| Temperature activation | | | | | | x | | | |
| UV activation | | | | | | | x | | |
| C | 51.7 | 53.5 | 52.8 | 48.4 | 51.8 | 54.5 | 52.8 | 52.1 | 50 |
| N | 1.1 | 1.8 | 1.3 | 3.2 | 0.6 | 1.8 | 3.6 | 4.2 | 0.4 |
| O | 13.0 | 22.5 | 14.0 | 24.2 | 8.5 | 14.0 | 21.5 | 17.7 | 7.7 |
| F | 27.8 | 0.5 | 24.9 | 0 | 36.5 | 22.4 | 3.9 | 8.3 | 39.8 |
| Si (Silicone) | 4.5 | 21.7 | 5.3 | 24.2 | 1.3 | 5.8 | 18.2 | 17.7 | 0 |
| Si (SiO₂ filler in PVDF) | 1.9 | 0.0 | 1.8 | | 1.3 | 1.5 | 0 | 0.0 | 1.7 |
| Total | 100.0 | 100.0 | 100.0 | 100.0 | 100.0 | 100.0 | 100.0 | 100.0 | 100.0 |
| Evaluation of the coating | − | − | − | | − | − | + | | |

PVDF comprises SiO₂ as filler (binding energy according to XPS: 103.7+/−0.1 eV); signal of the modified silicone at 1022.4(+/−0.1) eV according to XPS. This explains the oxygen- and silicon-containing composition compared to theory of 50% C and 50% F.
Explanation of Tables 1-5, evaluation of the adhesion between substrate and coating material:
no reliable coating detectable: −;
coating detectable: +

### 3) Investigation of the Adhesion Properties of PFPA-Containing Siloxane Oligomer (PFPA)₂-(NH15D) in Thermal Crosslinking RTV-2 Compositions (Elastosil® RT604 A/B)

To produce the RTV-2 silicone compositions, mixture A and B are mixed at a 1:1 mass ratio (for example using a Speedmixer from Hausschild).

a) for the additive, 5% by weight of the PFPA-containing siloxane oligomer (PFPA)₂-(NH15D) is added and mixed by hand or using a Speedmixer.

b) The polypropylene test pieces are primed with a 10% by weight solution of the PFPA-containing siloxane oligomer (PFPA)₂-(NH15D) in ethyl acetate, which evaporates rapidly at room temperature. The amounts used are found in Table 6 below, likewise all crosslinking conditions.

TABLE 6
Investigation of the adhesion of an RTV-2 silicone elastomer with and without addition of the
PFPA-containing siloxane oligomer (PFPA)₂-(NH15D)

| | Application of (PFPA)₂(NH15D) | | |
|---|---|---|---|
| Batch: | in the RTV-2 system | Crosslinking-/activation conditions | Result |
| | Reference | | |
| 47 | RTV-2: ELASTOSIL ® RT604 | 1 h at 80° C. | ○ |
| 48 | RTV-2: ELASTOSIL ® RT604 | 1 h at 140° C. | ○ |
| | a) Additive | | |
| 49 | 5% by weight additive | 1 h at 140° C. | ○ |
| 50 | 5% by weight additive | 1) 20 min at 80° C., 2) 40 min at 140° C. | + |
| | b) Priming | | |
| 51 | 50 μL (10% by weight in EtOAc) | 1) 80° C. (vacuum), 2) 1 h at 140° C. | + |
| 52 | 50 μL (10% by weight in EtOAc) | 1) 80° C. (vacuum), 2) 1 h at 80° C., | + |
| | | 3) 1 h at 140° C. | |
| 53 | 50 μL (10% by weight in EtOAc) | 1) 80° C. (vacuum), 2) 1 h at 80° C., | + |
| | | 3) 2 × 10 min UV-C | |
| 54 | 100 μL (10% by weight in EtOAc) | 1) 80° C. (vacuum), 2) 1 h at 80° C., | + |
| | | 3) 1 h at 140° C. | |
| 55 | 100 μL (10% by weight in EtOAc) | 1) 80° C. (vacuum), 2) 1 h at 80° C., | + |
| | | 3) 2 × 10 min UV-C | |

Indices for evaluating the adhesion between silicone elastomer and polypropylene compared to the silicone elastomer without PFPA-containing siloxane oilgomer as adhesion promoter:
no adhesion = ○;
improved adhesion = +

1-15. (canceled)

16. A PFPA-containing siloxane oligomer mixture, comprising:
wherein the PFPA-containing siloxane oligomer mixture is selected from compounds of average formula (I)
[SiO_{4/2}]ₐ[RSiO_{3/2}]_{b}[R¹SiO_{3/2}]_{b′}[R₂SiO_{2/2}]_{c}[R¹₂SiO_{2/2}]_{c′}[RR¹SiO_{2/2}]_{c″}[R₃SiO_{1/2}]_{d} [R₂R¹SiO_{1/2}]_{d′}[RR¹₂SiO_{1/2}]_{d″}[R¹₃SiO_{1/2}]_{d′″} (I)
wherein the indices a, b, b′, c, c′, c″, d, d′, d″ and d′ specify the average content of the respective siloxane units in the mixture and are each independently a number in the range of 0 to 300, with the proviso that the sum total of all indices is in a range from 3 to 3500 and on average at least 2 R radicals are present;
wherein the radicals R¹ are each independently selected from the group consisting of (i) hydrogen, (ii) halogen, (iii) C₁-C₂₀-hydrocarbon radical, (iv) hydroxyl radical and (v) C₁-C₂₀-hydrocarbonoxy radical;
wherein the radicals R are identical and refer to a radical of the formula 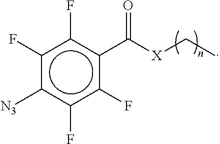
wherein the radical X is selected from (i) —O— or (ii) —NH—; and
wherein the index n (i) is a value in the range from 0 to 10 when X=—O—, and (ii) is a value in the range from 1 to 10 when X=—NH—.

17. The mixture of claim 16, wherein in the formula (I) the radicals R¹ are each independently selected from the group consisting of (i) hydrogen radical, (ii) methyl radical, (iii) ethyl radical, (iv) phenyl radical, (v) vinyl radical, (vi) hydroxyl radical, and (vii) C₁-C₂₀-alkoxy radical.

18. The mixture of claim 16, wherein in the radicals R in formula (I), the radicals X are each independently selected from (i) —O— or (ii) —NH—, in which the index n (i) has a value in the range of 0 to 6 when X=—O—, and (ii) has a value in the range of 1 to 6 when X=—NH—.

19. The mixture of claim 16, wherein in the formula (I) the indices a, b, b′, c, c′, c″, d, d′, d″ and d′″ each independently have the following definitions:
wherein a=a number in the range from 0 to 250;
wherein b=a number in the range from 0 to 50;
wherein b′=a number in the range from 1 to 250;
wherein c=a number in the range from 1 to 280;
wherein c′=a number in the range from 1 to 280;
wherein c″=a number in the range from 1 to 280;
wherein d=a number in the range from 0 to 250;
wherein d′=a number in the range from 0 to 250;
wherein d″=a number in the range from 0 to 250;
wherein d′″=a number in the range from 0 to 250; and
wherein the sum total of all indices is in the range of 3 to 3000 and on average at least 2 and at most 20 R radicals are present.

20. The mixture of claim 16, wherein the mixture is used as adhesion promoters.

21. A mixture, comprising:
a) at least one PFPA-containing siloxane oligomer mixture, wherein the PFPA-containing siloxane oligomer mixture is selected from compounds of average formula (I)
[SiO_{4/2}]ₐ[RSiO_{3/2}]_{b}[R¹SiO_{3/2}]_{b′}[R₂SiO_{2/2}]_{c}[R¹₂SiO_{2/2}]_{c′}[RR¹SiO_{2/2}]_{c″}[R₃SiO_{1/2}]_{d} [R₂R¹SiO_{1/2}]_{d′}[RR¹₂SiO_{1/2}]_{d″}[R¹₃SiO_{1/2}]_{d′″} (i),
wherein the indices a, b, b′, c, c′, c″, d, d′, d″ and d′ specify the average content of the respective siloxane units in the mixture and are each independently a number in the range of 0 to 300, with the proviso that the sum total of all indices is in a range from 3 to 3500 and on average at least 2 R radicals are present;
wherein the radicals R¹ are each independently selected from the group consisting of (i) hydrogen, (ii) halogen, (iii) C₁-C₂₀-hydrocarbon radical, (iv) hydroxyl radical and (v) C₁-C₂₀-hydrocarbonoxy radical;
wherein the radicals R are identical and refer to a radical of the formula 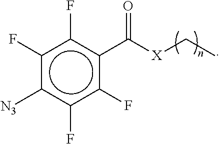
wherein the radical X is selected from (i) —O— or (ii) —NH—; and
wherein the index n (i) is a value in the range from 0 to 10 when X=—O—, and (ii) is a value in the range from 1 to 10 when X=—NH—; and
b) at least one natural or synthetic polymer selected from the group consisting of
b1) addition-crosslinking silicone compositions; or
b2) condensation-crosslinking silicone compositions; or
b3) hybrid materials/STP; or
b4) inorganic and/or organic polymers.

22. The mixture of claim 21, wherein the mixture is a molding and a weakly polar to non-polar substrate.

23. The mixture of claim 22, wherein the substrate is selected from synthetic hydrocarbon polymers, such as polyolefins of mono- or polyenes, polyhaloolefins, polyethers, polyvinyl chloride, polyvinylidene difluoride, polycarbonates, polyesters, and copolymers of the corresponding monomers (e.g. EPDM or acrylonitrile-butadiene-styrene (ABS)) and any polymer blends of the polymers and/or copolymers mentioned above.

24. The mixture of claim 21, wherein the mixture is a self-adhesive silicone composition coating materials for weakly polar to non-polar substrates.

25. The mixture of claim 24, wherein the substrate is selected from synthetic hydrocarbon polymers, such as polyolefins of mono- or polyenes, polyhaloolefins, polyethers, polyvinyl chloride, polyvinylidene difluoride, polycarbonates, polyesters, and copolymers of the corresponding monomers (e.g. EPDM or acrylonitrile-butadiene-styrene (ABS)) and any polymer blends of the polymers and/or copolymers mentioned above.

26. A method for preparing a mixture, comprising:
providing at least one PFPA-containing siloxane oligomer mixture, wherein the PFPA-containing siloxane oligomer mixture is selected from compounds of average formula (I)
[SiO_{4/2}]ₐ[RSiO_{3/2}]_{b}[R¹SiO_{3/2}]_{b′}[R₂SiO_{2/2}]_{c}[R¹₂SiO_{2/2}]_{c′}[RR¹SiO_{2/2}]_{c″}[R₃SiO_{1/2}]_{d} [R₂R¹SiO_{1/2}]_{d′}[RR¹₂SiO_{1/2}]_{d″}[R¹₃SiO_{1/2}]_{d′″} (i),
wherein the indices a, b, b′, c, c′, c″, d, d′, d″ and d′″ specify the average content of the respective siloxane units in the mixture and are each independently a number in the range of 0 to 300, with the proviso that the sum total of all indices is in a range from 3 to 3500 and on average at least 2 R radicals are present;
wherein the radicals R¹ are each independently selected from the group consisting of (i) hydrogen, (ii) halogen, (iii) C₁-C₂₀-hydrocarbon radical, (iv) hydroxyl radical and (v) C₁-C₂₀-hydrocarbonoxy radical;
wherein the radicals R are identical and refer to a radical of the formula 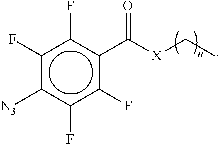
wherein the radical X is selected from (i) —O— or (ii) —NH—; and
wherein the index n (i) is a value in the range from 0 to 10 when X=—O—, and (ii) is a value in the range from 1 to 10 when X=—NH—; and
curing the mixture by thermal and/or photochemical activation.

27. The method of claim 26, wherein the curing takes place by a one-stage or multi-stage thermal activation in the temperature range of 0° C. to 200° C.

28. The method of claim 27, wherein the thermal activation takes place in a temperature range of 10° C. to 180° C.

29. The method of claim 27, wherein the curing is effected by a two-stage thermal activation, comprising the following steps:
a) thermal activation at a temperature T1 in a temperature range of 0° C. to 140° C.; and
b) thermal activation at a temperature T2 in a temperature range of 120° C. to 180° C.;
wherein it must apply that: T1<T2.

30. The method of claim 26, wherein the curing is effected by a one-stage or multi-stage photochemical activation with actinic radiation in the wavelength range of 800 nm to 50 nm.
